(19) United States
(12) Patent Application Publication
(10) Pub. No.: US 2020/0379794 A1
(43) Pub. Date: Dec. 3, 2020

(54) METHOD FOR CONTAINERIZING APPLICATION ON CLOUD PLATFORM

(71) Applicants: NAMU TECH CO., LTD., Seongnam-si, Gyeonggi-do (KR); ACORNSOFT CO., LTD., Seoul (KR)

(72) Inventor: In Seok KIM, Goyang-si, Gyeonggi-do (KR)

(21) Appl. No.: 16/606,965

(22) PCT Filed: Apr. 30, 2018
(86) PCT No.: PCT/KR2018/004992

§ 371 Date: Oct. 21, 2019

(30) Foreign Application Priority Data
May 2, 2017 (KR) 10-2017-0056483

(51) Int. Cl. G06F 9/455; G06F 9/50; H04L 29/08

(52) U.S. Cl. CPC G06F 9/45558; G06F 9/5077; G06F 2009/45587; G06F 2009/45595; H04L 67/1097

(57) ABSTRACT

A method for containerizing an application in a cloud platform has effects of providing an isolated application execution environment, allowing independent resource allocation, enabling multiple applications to operate on the same host, allowing fast handling through OS-level virtualization, enabling efficient deployment and updating due to a small size of container image, and allowing the container image to be moved anywhere.

### TECHNICAL FIELD

The present invention relates to a method for containerizing an application on a cloud platform, and more particularly, to a method for containerizing an application on a cloud platform, which provides an isolated application execution environment, allows independent resource allocation, enables multiple applications to operate on the same host, allows fast handling through OS-level virtualization, enables efficient deployment and updating due to a small size of container image, and allows the container image to be moved anywhere.

### BACKGROUND ART

A cloud is referred to as “a service provider server” depending on the practices that displays a computing service provider server in a cloud shape. Only when the cloud stores software and data in a central computer connected to the Internet to access the Internet, the data may be used anytime and anywhere.

The cloud may be divided into Software as a Service (SaaS) which is an application service provided to multiple users with on-demand, such as ‘Salesforce.com’ and ‘Google e-mail’, Platform as a Service (PaaS) which is a software stack required for execution of developing platforms or applications such as AWS RDS, Google AppEngine, and Infrastructure as a Service (IaaS) providing a server or storage to a user in a service form such as AWS EC2, according to a service providing form.

In addition, the cloud may be divided into a private cloud operated only for a group, a public cloud rendered through an open network for public use, and a hybrid cloud as a combination of two or more clouds which has distinct identities, but are tired together, according to introducing and deploying forms.

Meanwhile, in the enterprise cloud, it is more important to customize and optimize the technology and infrastructure based on an application service with a cloud implementing business and IT strategy of a company, and it should be easy to configure or deploy the application in various infrastructures.

### DISCLOSURE

### Technical Problem

Therefore, in order to solve these problems, an object of the present invention is to provide a method for containerizing an application in a cloud platform which provides an isolated application execution environment, allows independent resource allocation, enables multiple applications to operate on the same host, allows fast handling through OS-level virtualization, enables efficient deployment and updating due to a small size of container image, and allows the container image to be moved anywhere.

However, technical objects of the present disclosure are not restricted to the technical object mentioned as above. Unmentioned technical objects will be apparently appreciated by those skilled in the art by referencing the following description.

### Technical Solution

According to an embodiment of the present invention, there is provided a method for containerizing an application on a cloud platform, comprising: selecting, by a cloud platform system, a container conversion target from existing applications by considering container/cloud introducing purposes and strategies; analyzing, by the cloud platform system, the target application when the target application is selected; designing, by the cloud platform system, a target application-specific container configuration by considering the separation/integration, association, availability, extendibility, and security; designing, by the cloud platform system, a infrastructure configuration; establishing, by the cloud platform system, a container conversion scheme when the infrastructure configuration is designed; repetitively and incrementally converting, by the cloud platform system, a pre-test (PoC), an application-specific graded conversion, etc.; configuring, by the cloud platform system, a cluster; configuring, by the cloud platform system, an application container and converting an application by changing a setting and a source of the application if necessary; converting, by the cloud platform system, data by converting a target application container, setting a server by a persistence volume setting and the like, extracting data, and transmitting the data to the server; deploying, by the cloud platform system, a verified container to the server, performing an application function and performance test, and reflecting a testing result to the container and the infrastructure; generating, by the cloud platform system, an operation cluster, generating and linking the server based on the conversion-completed image, transferring operation data, and opening the application; performing, by the cloud platform system, application and infrastructure operation monitoring through a cloud monitoring view and reflecting performance issue and error; and reporting, by the cloud platform system, a container transfer result to transfer and apply a development and operation system.

The analyzing of the target application may include examining, by the cloud platform system, an application status and data such as applications, infrastructures, data, applications and associated structures, collecting development and operation, and the needs of a manager, and deriving a container configuration direction, issues and solutions.

The designing of the target application-specific container configuration may include defining, by the cloud platform system, an image build template such as a base image, environment variables, including items, and commands.

The designing of the infrastructure configuration may include selecting, by the cloud platform system, a conversion infrastructure (Cloud/Bare Metal) provider, calculating a capacity for each application container, calculating the number of container cluster nodes and an infrastructure capacity, and designing storage, network and security configurations.

The establishing of the container conversion scheme may include establishing, by the cloud platform system, a detailed conversion scheme for each application, defining a conversion work and an organization/role, establishing a conversion schedule, and reflecting a report and a feedback.

The configuring of the cluster may include installing and configuring, by the cloud platform system, a cloud platform, configuring an infrastructure such as a network, a share, a storage, and security, generating a cocktail service and a cluster by allocation of the infrastructure and a user's registration, and verifying a cluster configuration.

The converting of the application may include verifying, by the cloud platform system, functions and settings of the conversion container, registering the functions and settings in a container deployment image build and registry, and generating and testing the server.

The converting of the data may include performing, by the cloud platform system, data conversion and checking data integrity when the DB solution is applied, and applying a data synchronization solution to minimize a downtime in the case of an operation application.

### Advantageous Effects

According to the present invention, the method for containerizing an application on a cloud platform has effects of providing an isolated application execution environment, allowing independent resource allocation, enabling multiple applications to operate on the same host, allowing fast handling through OS-level virtualization, enabling efficient deployment and updating due to a small size of container image, and allowing the container image to be moved anywhere.

### DESCRIPTION OF DRAWINGS

FIG. 1 illustrates a configuration diagram of a cloud platform system according to an embodiment of the present invention.

FIG. 2 illustrates briefly a function of a cloud integration unit of FIG. 1.

FIG. 3 illustrates briefly a function of a service management unit of FIG. 1.

FIG. 4 illustrates briefly a function of an application orchestration unit of FIG. 1.

FIG. 5 illustrates a framework for application containerizing according to one embodiment of the present invention.

FIGS. 6 to 11 illustrate briefly functions of a development/operation unit of FIG. 1.

FIG. 12 illustrates an architecture of a cloud platform system according to an embodiment of the present invention.

FIG. 13 illustrates a configuration of a cocktail server and surrounding architectures thereof.

### MODES OF THE INVENTION

Advantages and features of the present disclosure, and methods for accomplishing the same will be more clearly understood from exemplary embodiments described in detail below with reference to the accompanying drawings. However, the present invention is not limited to the embodiments set forth below, and may be embodied in various different forms. The present embodiments are just for rendering the disclosure of the present invention complete and are set forth to provide a complete understanding of the scope of the invention to a person with ordinary skill in the technical field to which the present invention pertains, and the present invention will only be defined by the scope of the claims.

Like reference numerals refer to like elements throughout the specification.

Hereinafter, a cloud platform system according to an embodiment of the present invention will be described with reference to the accompanying drawings.

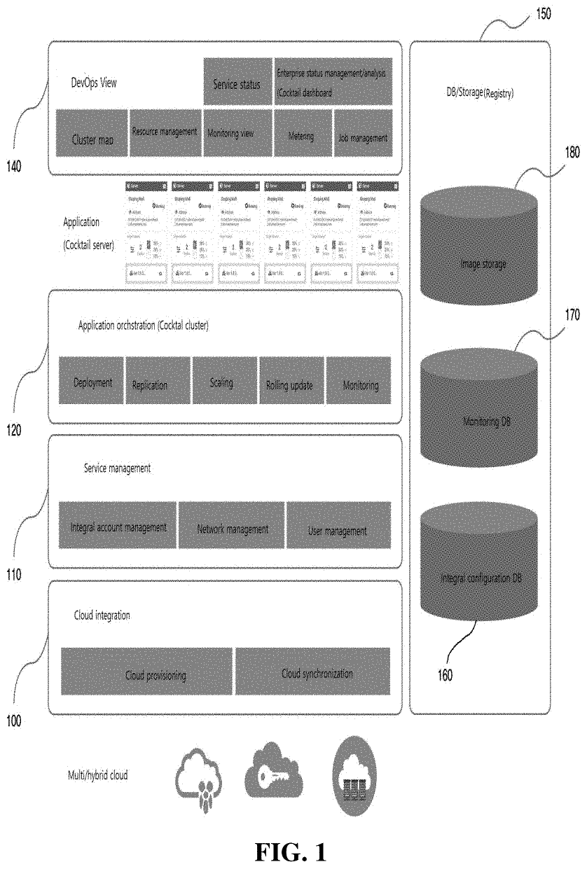

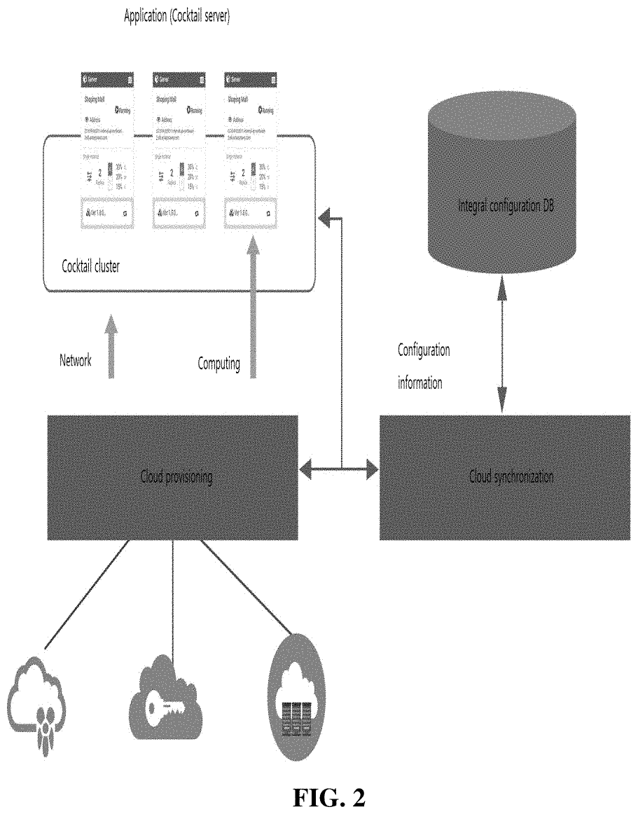

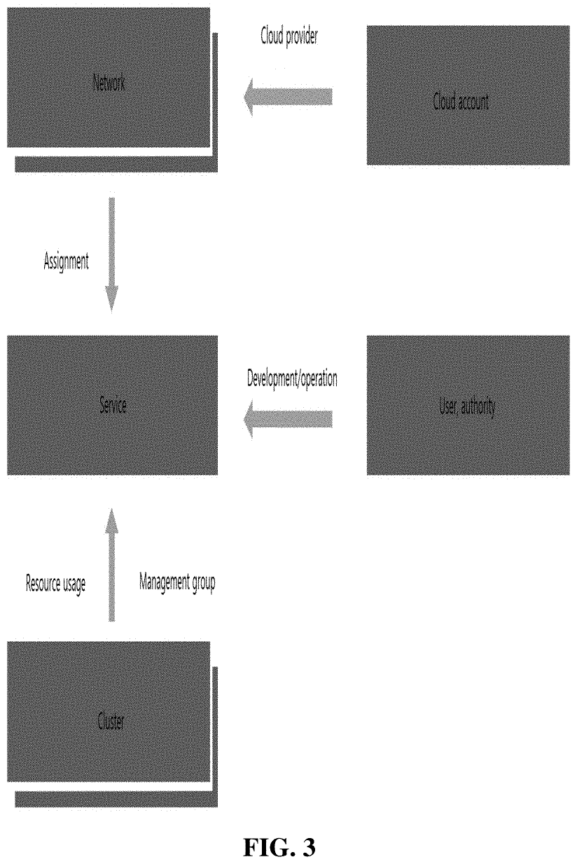

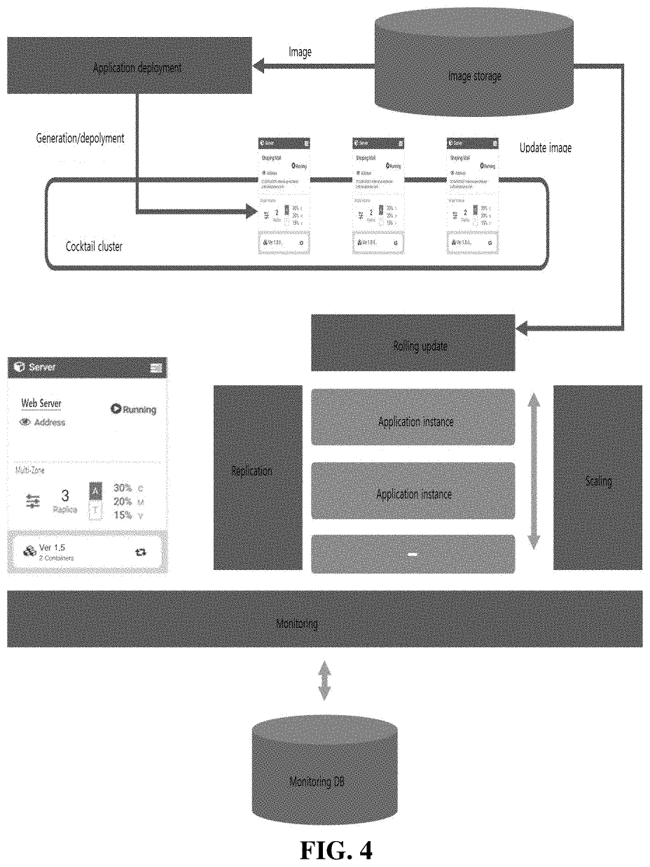

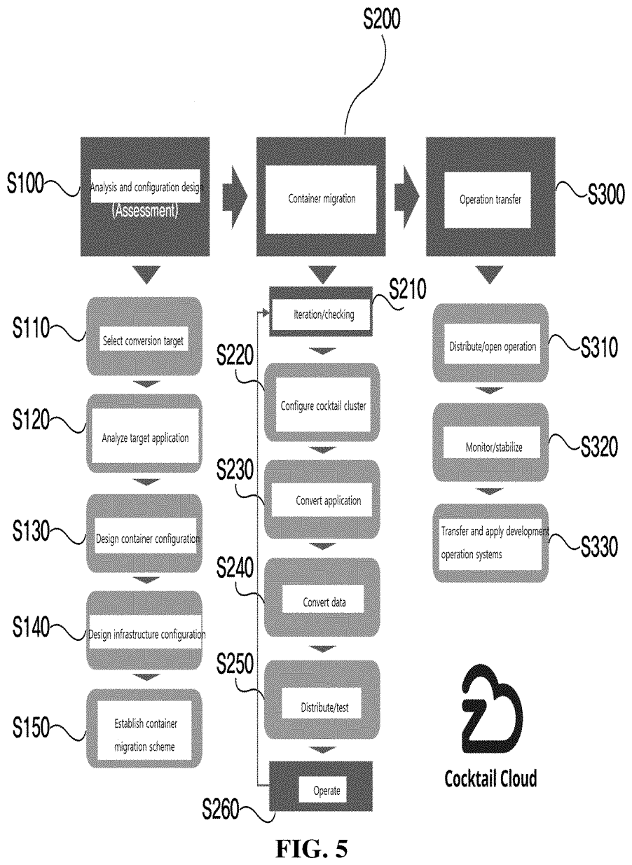

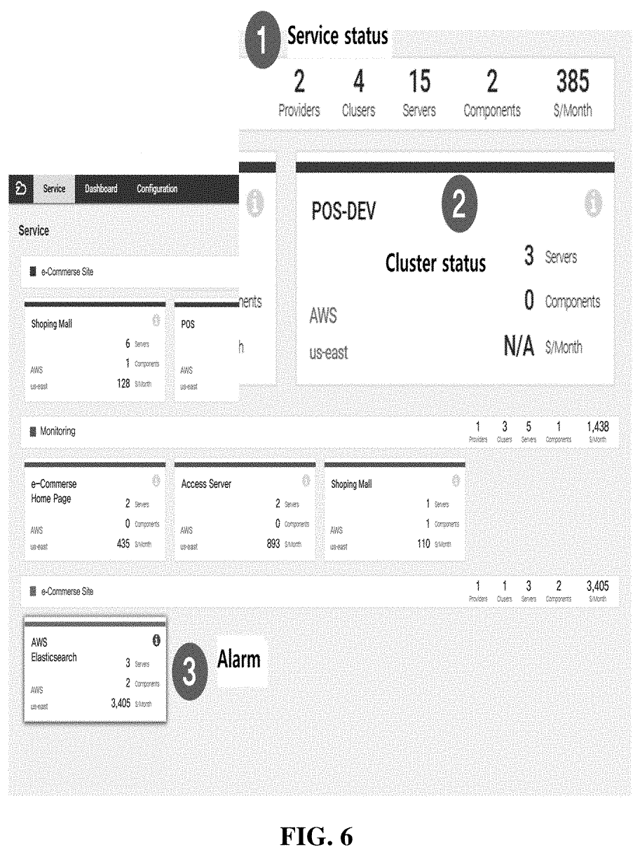

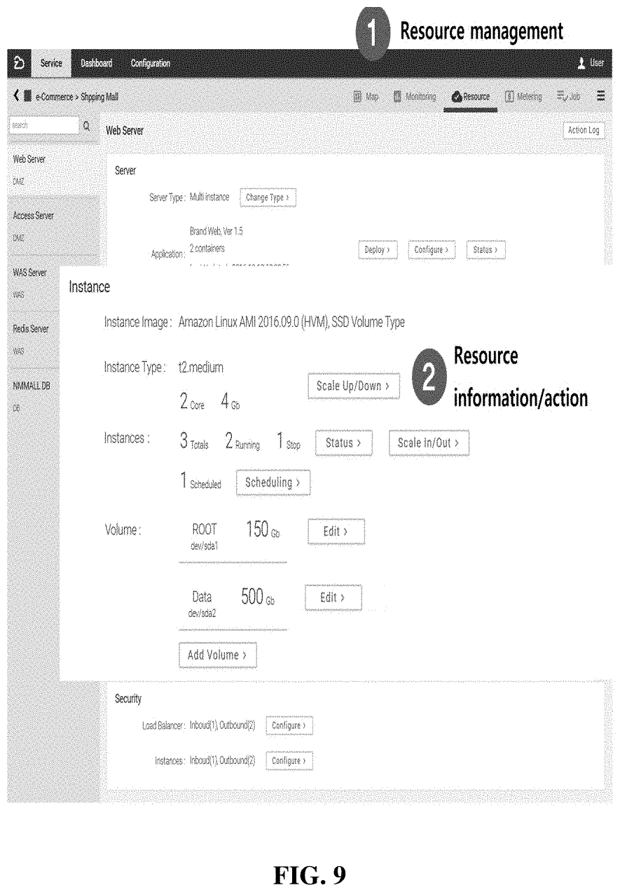

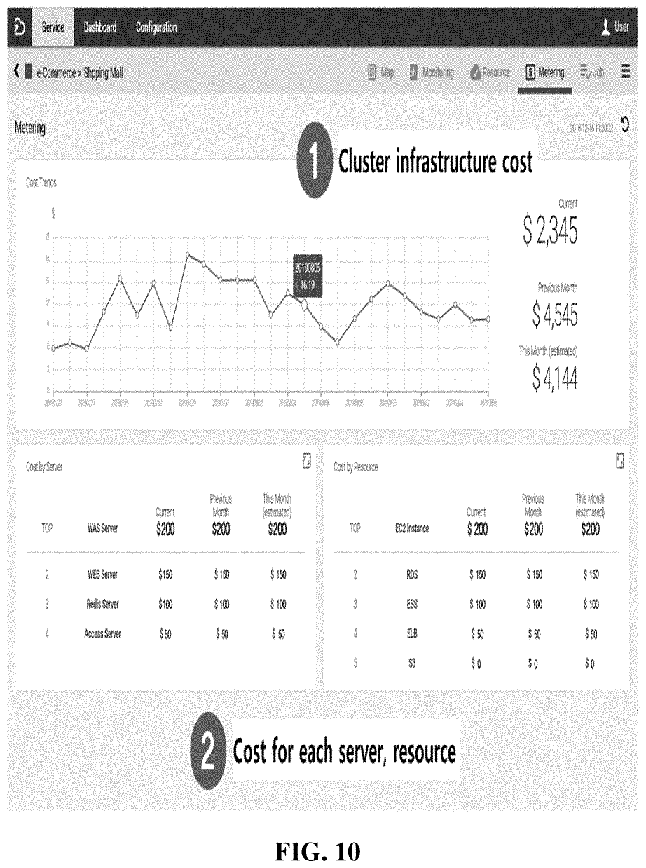

FIG. 1 illustrates a configuration diagram of a cloud platform system according to an embodiment of the present invention, FIG. 2 illustrates briefly a function of a cloud integration unit of FIG. 1, FIG. 3 illustrates briefly a function of a service management unit of FIG. 1, and FIG. 4 illustrates briefly a function of an application orchestration unit of FIG. 1. FIG. 5 illustrates a framework for application containerizing according to one embodiment of the present invention and FIGS. 6 to 11 illustrate briefly functions of a development/operation unit of FIG. 1.

A cloud platform system of FIG. 1 provides a view and a tool for ensuring the availability and extendibility of application and enabling efficient development and operation based on integral management of a multi/hybrid cloud. Hereinafter, a cloud platform system of the present invention is referred to as a “cocktail cloud”.

Referring to FIG. 1, a cocktail cloud includes a cloud integration unit 100, a service management unit 110, an application orchestration unit 120, a development/operation unit (DevOps View) 140, and a DB/storage 150.

The cloud integration unit 100 automatically configures an infrastructure of a multi/hybrid cloud to provide the configured infrastructure to an application and synchronize configuration information for management.

The cloud integration unit 100 performs cloud provisioning and cloud synchronization functions.

Referring to FIG. 2, the cloud provisioning function is a function of configuring and providing a cloud network infrastructure to an application cluster (cocktail cluster) and configuring and providing a computing infrastructure of the cloud to the application. In addition, a physical infrastructure (Bare Metal) provides a cluster configuration tool. A support cloud may include AWS, Azure, Aliyun, Google Computing Engine for Public, Openstack, and VMWear for private, and further include On-premise and Datacenter BareMetal Infra.

The cloud synchronization function is a function of storing and managing cloud infrastructure configuration information in an integral configuration DB 160 and synchronizing infrastructure change information with the integral configuration DB 160 when operating.

The service management unit 110 serves to assign and manage a cloud account and a user network resource to a logical group of managing an application cluster. That is, the service management unit 110 performs an integrated account management function, a network management function, and a user management function.

Referring to FIG. 3, the integrated account management (Cloud Provider) function is a function of integrally managing a multi-cloud account and access information and being used for a network and a cloud providing configuration.

The network management function is a function of configuring a cloud network and assigning the configured cloud network to a service. For example, the service may be VPC and Subnet of AWS. One service generates a cluster using a network of a provider of a multi-cloud to configure and operate the application.

The user management function is a function of managing team members managing services and authority required for development/operation. Here, the authority may include enterprise service management authority (Admin), enterprise service inquiry authority (Manager), service management authority (DevOps) assigned to members, etc. The user may participate as a member on several services.

The application orchestration unit 120 plays a key function of a cocktail cluster to ensure the deployment, availability, and extendibility of applications.

The application orchestration unit 120 performs an application deployment function, a replication control function, a rolling update function, a scaling function, and a monitoring function.

Referring to FIG. 4, the application deployment function is a function of providing easiness without requiring a separate setting and a configuration job with container image-based deployment and automatically provisioning the cloud infrastructure when the application is deployed.

Here, the application is to be containerized and deployed, and the application container (hereinafter, referred to as a “container”) means an independent system on the OS which assigns, isolates, and visualizes host resources in an application process.

The core technology used in the container is a control group (cgroup) and namespace of Linux. The cgroup makes a corresponding process group and performs assignment and management of resources in order to assign the host resource to the process on the OS. The namespace is a technique to isolate a process, a network, and a mount to a specific name space. Accordingly, the container means an independent system which assigns resources to the application process via the cgroup and is virtualized on the OS isolated by the namespace.

The container is a technique suitable for application virtualization which has almost no consumption of host resources and a very small time required for starting as a light OS visualization method without using a hypervisor (hardware emulator) and a guest OS. Further, the container can be independently configured and deployed to an infrastructure such as a physical server (Bare Metal) AND a virtual server (Virtual Machine) by virtualization on the OS.

To convert the existing or new application configuration to a container, a containerization process should be involved. In addition, the conversion of development, testing, and operation should be parallel with a process of optimizing an operation infrastructure configuration (cocktails cloud platform).

In order to convert the existing application to the container, the settings and the conversion of a configuration rather than the source of the application are required. Considering deployment and operation efficiency, a role-specific independent configuration based on a workload is general and a configuration considering multiplexing and scaling through the replication is to be designed and applied.

For conversion of development, testing, and operation of the application, an application configuration needs to be standardized by building, testing, and deployment of an image-based application, and a base image.

In order to optimize the operation infrastructure configuration of the application container, a cluster-based infrastructure for a container orchestration is configured, a computing capacity considering replication and scaling needs to be calculated (minimizing a spare capacity, and easiness of expansion as necessary), and related infrastructures such as share, storage, security, and a network need to be configured.

Referring to FIG. 5, containerization is divided into analysis and configuration design (S100), container conversion (S200), and operating transfer (S300).

A container conversion target is selected from existing applications by considering container/cloud introducing purposes and strategies for the analysis and configuration design (S100) (S110).

When the target application is selected, the target application is analyzed (S120). At this time, an application status and data such as applications, infrastructures, data, applications and associated structures are examined and development and operation, and the needs of a manager are collected. In addition, a container configuration direction, issues and solutions are derived.

In addition, considering the separation/integration, association, availability, extendibility, and security, a target application-specific container configuration is designed (S130). At this time, an image build template such as a base image, environment variables, including items, and commands may be defined.

Then, an infrastructure configuration is designed (S140). A conversion infrastructure (Cloud/Bare Metal) provider is selected, and a capacity for each application container is selected. In addition, the number of container cluster nodes and an infrastructure capacity are calculated and storage, network and security configurations are designed.

When the infrastructure configuration is designed, a container conversion scheme is established (S150). At this time, a detailed conversion scheme for each application is established, the conversion work and organization/role are defined, and a conversion schedule is established. In addition, reporting and feedback are reflected.

A repetitive/incremental conversion (S210) is required for the container conversion (S200). A pre-test (PoC), an application-specific graded conversion, etc. are repetitively and incrementally converted.

In order to configure a cocktail cluster (S220), a cocktail cloud platform is installed and configured, and an infrastructure such as a network, a share, a storage, and security is configured (provisioning in the cocktail in the case of the cloud). A cocktail service and a cluster are generated by allocation of the infrastructure and a user's registration and a cluster configuration is verified.

In addition, for application conversion (S230), an application container is configured and application settings and source are changed if necessary. The functions and settings of the conversion container are verified and registered in a container deployment image build and registry. A cocktail server is generated and tested.

For data conversion (S240), a target application container is converted, a cocktail server is configured by a persistence volume setting and the like, and data is extracted and transmitted to the cocktail server. If the DB solutions is applied, data conversion is performed and data integrity is checked. In the case of the operation application, in order to minimize a downtime, a data synchronization solution is applied.

Thereafter, the verified container is deployed to the cocktail server, an application function and performance test are performed, and a test result is reflected to the container and the infrastructure (S250 and S260).

For operation transfer (S300), operation deployment/open (S310) is performed, and specifically, an operation cocktail cluster is generated and a cocktail server is generated based a conversion-completed image to be associated and configured. In addition, operation data is transferred and an application is opened. A technique of deploying, operating, and managing the application container is referred to as a container orchestration.

The container orchestration is a technique of deploying, operating, and managing the application container by configuring a managed cluster in a physical/virtual infrastructure, and has spread into a platform of clouding in the office and the data center infrastructure and application management of the private/public cloud by using advantages of light and fast starting and mobility of the container.

The operation monitoring of the application and the infrastructure are performed by the cocktail cloud monitoring view and performance issues and errors are reflected (S320).

For development, operating system transfer, and application (S330), a container transfer result is reported, a container-based development/operation system training is conducted in the organization responsible for the development and operation, and a cocktail cloud platform usage training is conducted.

Accordingly, the container has the following advantages.

First, the container has the independence.

The container is an isolated application execution environment, independent resources are allocated (CPU, Memory, Disk, Network, etc.), and multiple applications are operated on the same host.

Second, the container implements a light virtualization.

The container enables an OS-level virtualization (Non Hypervisor), allows fast handling (generation, execution, restarting, etc.), and enables efficient deployment and updating due to a small size of container image.

Third, the container has mobility.

The container has an infrastructure independent image, is movable anywhere such as a Bare Metal, a virtual machine, and a cloud, enables online deployment and version management by an image registry, and supports A main host OS (Linux series, Windows). The mobility of the container enhances productivity and efficiency of the application operation/development under a multi/hybrid cloud environment, and specifically, solves the difficulty in application deployment and transfer in a heterogeneous infrastructure with a standardized container image and solves a lock-in problem dependent on a specific cloud.

The replication control function is faster and more efficient than OS rebooting as a method of maintaining a specified initial replication number (multiplexing) for the stability and availability of the application and restarting when an error occurs through an application container health check. The replicated application is serviced through load balancing.

The rolling update function is a function of performing an update job such as deployment and infrastructure change without stopping the application service and configuring automation through a job management function of DevOps View when there are dependencies between multiple applications.

The scaling function is a function of in/out scaling of an instance through the monitoring of the application and up/down scaling of a resource capacity in the case of the application infrastructure. In addition, scaling automation is configured through monitoring information.

The monitoring function is a function of monitoring an instance (container+infrastructure) of the application, and generating and managing an alarm through a threshold setting.

The development/operation unit (DevOps View) 140 includes a service status function, a cluster map function, a monitoring view function, a resource management function, a metering function, a job management function, and an enterprise status management/analysis function. The respective functions will be described below with reference to FIGS. 6 to 11.

The service status function provides a view that may determine a status of a cluster of all applications of the cocktail cloud based on the service (see FIG. 6). Then, items of a service status, a cluster status, a monitoring alarm, etc. may be displayed.

In the service status, the entire service status of the cocktail cloud may be inquired and a cloud provider, a cluster, a server, a cloud component, current month using cost, etc. may be determined by synthesizing a configuration status of the cluster in the service. Here, the cluster means a configuration unit of the application and the service means a logical group of the cluster.

In the cluster status, a provider, a region, a server, a cloud component, and month using cost can be inquired in a card form and in the physical (Bare Metal) cluster, the using cost may be excluded.

In the monitoring alarm display function, when an alarm occurs in the application and the infrastructure of the cluster, the cluster status may be checked in a cluster card.

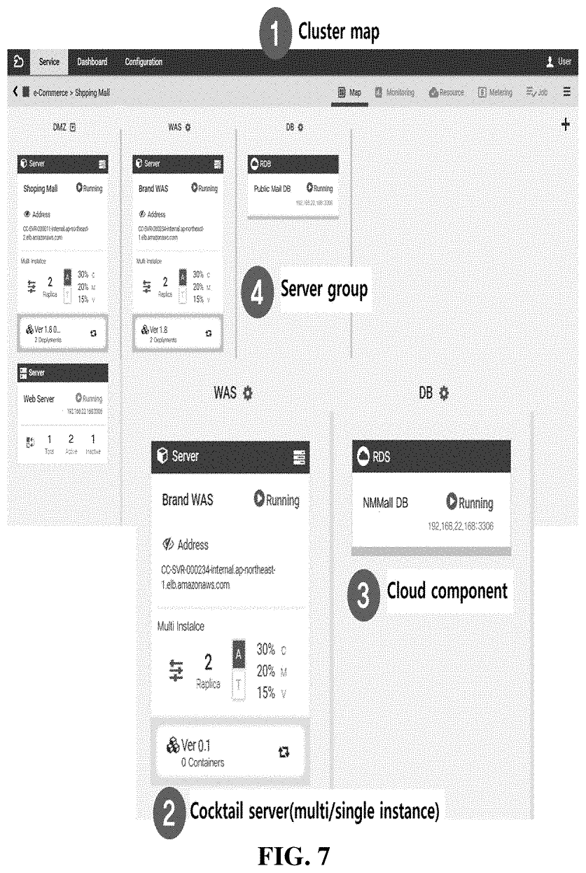

The cluster map function provides a view by visualizing and managing a configuration and status information of the cocktail server (application) in a map form (see FIG. 7).

The cluster map inquires/manages a configuration of a server of the cluster and a cloud component in a map form to enhance visibility of the configuration information. The cluster map may include items such as a cocktail server, a cloud component, and a server group.

The cocktail server is configured by a load balancing, an application container, and an infrastructure as a basic unit of the application orchestration, and provides an interface standardized for multi/hybrid cloud management. The cocktail server checks application status and replication and a resource usage in the server and manages scaling, rolling update, etc. The cocktail server is divided into multi and single instance types according to a replication function. In AWS, a multi-zone option is supported.

The cloud component manages PaaS services provided by a supplier. For example, the cloud component may be RDS as a DB service of AWS.

The server group provides a logical group of a server configuration to management convenience.

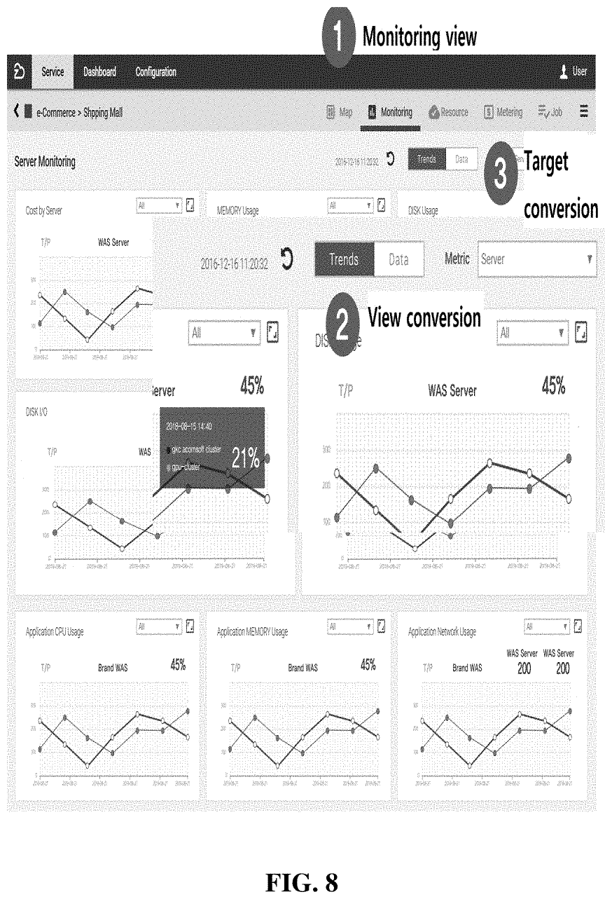

The monitoring view function provides information capable of checking a resource capacity and a status of the application and the infrastructure in the cluster and a status of a cloud resource (see FIG. 8).

The monitoring view visualizes and provides the monitoring information on the application and infrastructure in the cluster and checks a usage of resources by providing a CPU, a memory, an average of a disk, and TOP information to correspond to operation.

The monitoring view may include a view conversion (trend/data) item, a target conversion (server/resource), etc.

In view conversion item, a trend view provides monitoring information for each time for the server, the replicated instance, and the application container and the data view provides an average of the current time, and a TOP monitoring value.

In the target conversion item, a monitoring target is divided into a server in the cluster and a resource of the cloud infrastructure. The cloud resource uses information provided by the supplier.

The resource management function checks a resource of the cloud infrastructure configuring the application and provides a view (hereinafter, referred to as a “resource management view”) capable of adjusting detailed settings if necessary.

The resource management view may check a cloud infrastructure resource configuring the cocktail server and change settings specifically. Here, the cocktail server automatically performs a basic configuration for the application orchestration, but is used when there is a need for adjusting a cloud resource directly if necessary.

The resource management view includes a resource information/action item and the application of the resource information manages container configuration and deployment information. The cloud resource information consists of a load balancer, an instance (VM), and a security, and the instance manages a capacity and a volume. Resource information required for adjustment is performed through an action.

The metering function provides a view (hereinafter, referred as a “metering view”) capable of checking cost information of the cloud infrastructure resource used for the application. The metering view may include a cluster infrastructure use cost item, a cost item for each server or resource, and the like.

In the cluster infrastructure use cost item, a cost status of the cloud resource used by the cluster and the cocktail server may be checked and previous month and current month cost information, and next month estimation cost are provided. Further, a cost increase and decrease trend graph for each month is provided.

Cost items for each server and each resource provides cloud resource cost used for each cocktail server based on TOP and provides cost used for cloud resource type based on TOP.

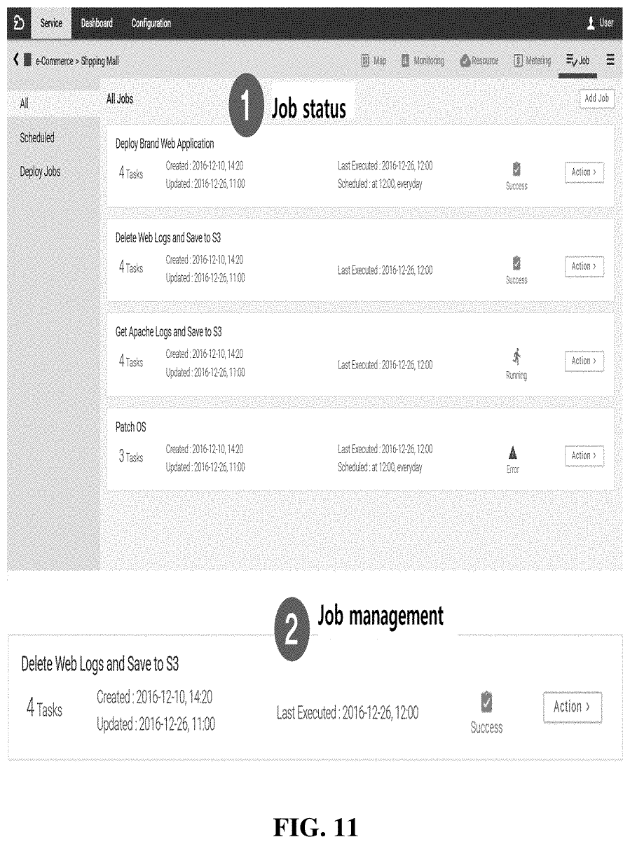

The operation management function provides a management view (hereinafter referred to as a “job management view”) capable of scheduling/automating an operation job such as deployment, a remote command, and resource management (see FIG. 11).

The job management view provides scheduling and batch-processing for operating the applications and the infrastructure. The job management view may include a job status item, a job management item, etc.

In the job management view, the job status item is divided into deployment, a remote command, and a resource management task and configured by combining respective tasks.

Here, the deployment refers to application deployment, the remote command means performing an OS command in remote, and the resource management means scaling, and a status/setting change.

In the job management view, the job management item may set a performing method according to immediately performing, scheduling, and occurrence of an alarm. The performance according to the occurrence of the alarm is used in automatic scaling according to a reference value of the capacity monitoring. In the job management item, an execution state and a log check of the job are provided.

The enterprise status management/analysis function provides a cocktail dashboard capable of determining and analyzing an enterprise application, a cloud, and a cost status.

The cocktail dashboard is a view of inquiring a status of the application and the cloud infrastructure in the enterprise level and providing cost/budget management, cost optimization analysis, and statistics reports. The cocktail dashboard may include an application status item, a cloud status item, a cost/budget management item, a cost optimization analysis item, and a statistics/report item.

The application status item enterprise-widely determines and inquires application and infrastructure statuses based on standardized elements of the server, the cluster, and the cloud component and provides a service-based status view.

The cloud status item determines a status of a cloud used for the enterprise for each provider, each region, and each resource and provides an infrastructure-based status.

The cost/budget management item and the cost optimization analysis items determine an enterprise cloud cost situation and provide information enabling efficient cloud resource cost by budget assignment/control and optimized analysis for each service.

The statistics/report item provides statistical information and a report view for analysis and reporting.

In the DB/storage 150, an image storage (registry) 180 manages registration, share, download, search, and version of the application container, a monitoring DB 170 manages monitoring information of the application and the infrastructure, and an integral configuration DB (configuration management DB, CMDB) 160 manages configuration information of a provider, a network, a service, a cluster, a server, a component, and a cloud resource.

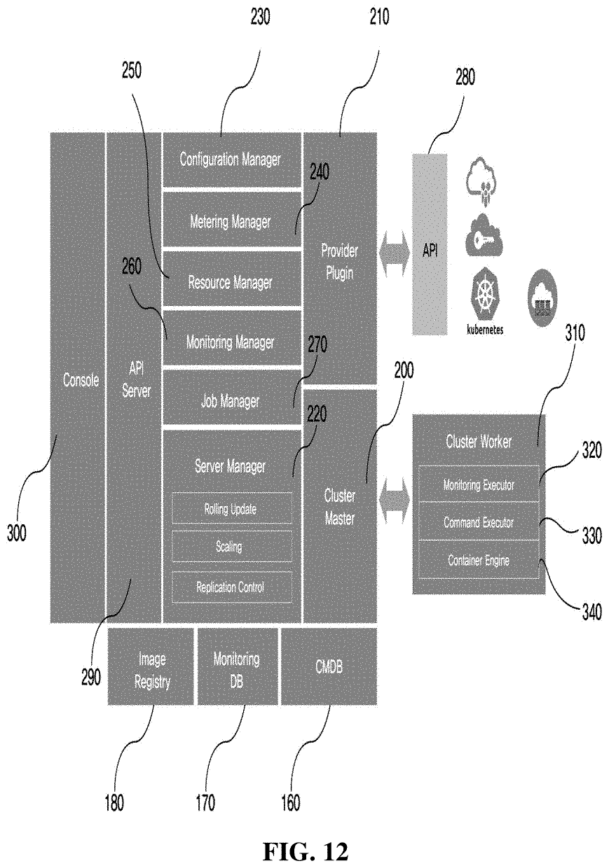

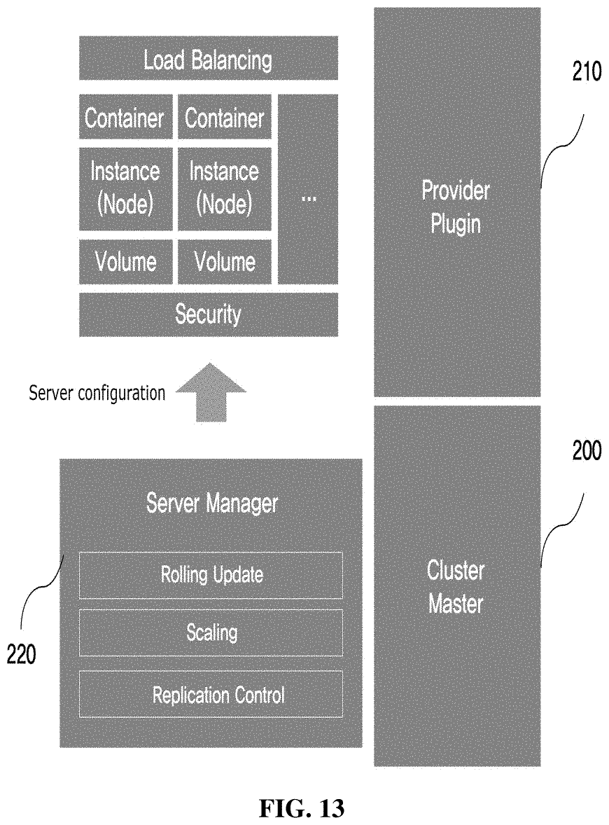

FIG. 12 illustrates an architecture of a cloud platform system according to an embodiment of the present invention and FIG. 13 illustrates a configuration of a cocktail server and surrounding architectures thereof.

Referring to FIG. 12, a cocktail cloud includes a cocktail cluster 200, a provider plugin 210, a server manager 220, a DevOps manager, a CMDB 160, a monitoring DB 170, an image registry 180, an API server 290, and a user console 300.

The cocktail cluster 200 provides an orchestration-based architecture and the provider plugin 210 is used as a basic module for integral management by a cloud provider API 280.

The cluster 200 is constituted by a node and a master and the node is a structure of processing a command of the master by a worker 310. The worker 310 is responsible for communication with the master and an executor is supported by an execution command. A monitoring executor 320 collects node and container monitoring information and a command executor 330 performs an OS and a container command. In addition, a container engine (docker) 340 is included.

The provider plugin 210 is an API rapper for supporting Kubernetes API for a multi-cloud and a bare metal and is configured by a plugin module for provider extension.

The cocktail server is a basic unit of the application orchestration and performs replication, scaling, and rolling update of the container and the cloud infrastructure by the cluster master 200 and the provider plugin 210.

The cocktail server is constituted by a container and a cloud infrastructure as illustrated in FIG. 13, and constituted by a load balancer, an instance (node), a container, a volume, and security, and may be, for example, ELB, EC2 Instance, Security Group, and ESB of AWS. The cocktail server provides a cloud component for PaaS of the cloud provider. For example, the cocktail server may be RDS of AWS.

The server manager 220 is a control module of performing an application container and orchestration of an infrastructure in the server, and provides a replication control to restart/recover a container abnormally terminated, scaling of performing scale in/out and up/down through an instance type and a volume extension, and a rolling update function of performing non-disruptively an application container deployment sequentially.

The DevOps manager, as a manager module of DevOps, provides a configuration manager 230 for provisioning a multi-cloud infrastructure, a metering manager 240 for managing a usage and cost of multi-cloud resources, a resource manager 250 for managing a resource status and settings of the multi-cloud, a monitoring manager 260 for collecting and managing container/infrastructure monitoring information, and a job manager 270 for a task of deployment, a server action, and a remote command in which various job tasks are combined and integrally performed and immediate performance, a performance time, and event occurrence are performance conditions.

The cocktail cloud provides a DB for managing configuration information of an application and an infrastructure, monitoring information, and an application container image and provides a user and an interface for programming.

The CMDB 160 manages configuration information of a provider, a network, a service, a cluster, a server, a component, and a cloud resource.

The monitoring DB 170 manages monitoring information of the application and the infrastructure.

The image registry 180 manages registration, share, download, search, and version of the application container.

The API server 290 provides all functions of the cocktail cloud to the API 280 and supports customization according to a corporate strategy and integration with other solutions.

The user console 300 is provided in a form of Web GUI.

The cocktail cloud may be used as follows.

First, the cocktail cloud may be used as a multi-cloud.

The cocktail cloud is a platform for integral management of a heterogeneous and complex multi-cloud environment by a standardized component and implements the entire business cloud quantity based on the application. Specifically, the cocktail cloud is a standardized management component for standardizing a managing target by the provider, the network, the service, the cluster, the server, and the cloud component and integrally managing a heterogeneous and complex multi-cloud resource (integral account, resource, and cost). Further, the application is a core resource of the business, and the availability and extendibility of the application are enhanced by the cocktail cluster and a development/operation work is efficient by the cocktail DevOps View, thereby implementing a business cloud based on the application.

Second, the cocktail cloud provides an infrastructure of construction/operation of a hybrid cloud by clouding a bare metal infrastructure within an office and a data center. The cocktail cloud also provides integral management and development/operation efficiency of a hybrid complex infrastructure.

Specifically, the application cluster is configured in the bare metal infrastructure in the office and the data center to construct a container-based cloud environment, so that a separate platform for virtualization is not required, availability and extendibility of scaling, etc., are provided, and a clouding of a physical infrastructure capable of integrally managing existing private and public clouds may be implemented.

Also, the cocktail cloud is managed by a standard component of the cocktail cloud and provides efficient development/operation work efficiency by the cocktail cloud DevOps view.

Third, the cocktail cloud provides a platform for efficient management of the application on the cloud and constructing and operating the Microsoft service through automation for the container and CI/CD.

The cocktail cluster provides an application deployment and management environment (cloud-native application) in a cloud infrastructure based on the container. Here, the cocktail cluster is a basic unit of constructing and managing a micro service.

Job management of the cocktail DevOps view provides an automated infrastructure capable of building and deploying the application and the container may be lighter and easier to perform the CI/CD. The cocktail cloud provides a platform that may deploy/operate applications on a multi/hybrid cloud.

Fourth, the cloud cocktail may be used also as an infrastructure resale and service providing platform of a cloud service broker.

The public cloud constructs and operates a CSB platform which manages a data center infrastructure and provides a resale and cloud management platform to a user in a service form, as a cocktail cloud, provides a multi-tenancy and billing system for SaaS, and can be used as a platform for providing and managing affiliate clouds in the case of large-scale enterprises.

Also, the public cloud clouds and provides an infrastructure of an existing data center provider and provides a service (cocktail cloud component (PaaS)) specified to a public cloud provider.

Meanwhile, the embodiments of the present invention may be prepared by a computer executable program and implemented by a universal digital computer which operates the program by using a computer readable recording medium. The computer readable recording medium includes storage media such as magnetic storage media (e.g., a ROM, a floppy disk, a hard disk, and the like), optical reading media (e.g., a CD-ROM, a DVD, and the like), and a carrier wave (e.g., transmission through the Internet).

As described above, according to the method for containerizing an application in a cloud platform of the present invention, it is possible to provide an isolated application execution environment, independently assign resources, operate multiple applications on the same host and enabling a fast operation with OS-level virtualization, be efficient in deployment and updating to a small size of container image, and be movable anywhere.

The present disclosure has been described above with reference to preferred embodiments thereof. It is understood to those skilled in the art that the present disclosure may be implemented as a modified form without departing from an essential characteristic of the present disclosure. Therefore, the disclosed embodiments should be considered in an illustrative viewpoint rather than a restrictive viewpoint. The scope of the present disclosure is defined by the appended claims rather than by the foregoing description, and all differences within the scope of equivalents thereof should be construed as being included in the present disclosure.

1. A method for containerizing an application on a cloud platform, comprising:
selecting, by a cloud platform system, a container conversion target from existing applications by considering container/cloud introducing purposes and strategies;
analyzing, by the cloud platform system, the target application when the target application is selected;
designing, by the cloud platform system, a target application-specific container configuration by considering the separation/integration, association, availability, extendibility, and security;
designing, by the cloud platform system, an infrastructure configuration;
establishing, by the cloud platform system, a container conversion scheme when the infrastructure configuration is designed;
repetitively and incrementally converting, by the cloud platform system, a pre-test (PoC), an application-specific graded conversion, etc.;
configuring, by the cloud platform system, a cluster;
configuring, by the cloud platform system, an application container and converting an application by changing a setting and a source of the application if necessary;
converting, by the cloud platform system, data by converting a target application container, setting a server by a persistence volume setting and the like, extracting data, and transmitting the data to the server;
deploying, by the cloud platform system, a verified container to the server, performing an application function and performance test, and reflecting a testing result to the container and the infrastructure;
generating, by the cloud platform system, an operation cluster, generating and linking the server based on the conversion-completed image, transferring operation data, and opening the application;
performing, by the cloud platform system, application and infrastructure operation monitoring through a cloud monitoring view and reflecting performance issue and error; and
reporting, by the cloud platform system, a container transfer result to transfer and apply a development and operation system.

2. The method for containerizing an application on a cloud platform of claim 1, wherein the analyzing of the target application includes examining, by the cloud platform system, an application status and data such as applications, infrastructures, data, applications and associated structures, collecting development and operation, and the needs of a manager, and deriving a container configuration direction, issues and solutions.

3. The method for containerizing an application on a cloud platform of claim 1, wherein the designing of the target application-specific container configuration includes defining, by the cloud platform system, an image build template such as a base image, environment variables, including items, and commands.

4. The method for containerizing an application on a cloud platform of claim 1, wherein the designing of the infrastructure configuration includes selecting, by the cloud platform system, a conversion infrastructure (Cloud/Bare Metal) provider, calculating a capacity for each application container, calculating the number of container cluster nodes and an infrastructure capacity, and designing storage, network and security configurations.

5. The method for containerizing an application on a cloud platform of claim 1, wherein the establishing of the container conversion scheme includes establishing, by the cloud platform system, a detailed conversion scheme for each application, defining a conversion work and an organization/role, establishing a conversion schedule, and reflecting a report and a feedback.

6. The method for containerizing an application on a cloud platform of claim 1, wherein the configuring of the cluster includes installing and configuring, by the cloud platform system, a cloud platform, configuring an infrastructure such as a network, a share, a storage, and security, generating a cocktail service and a cluster by allocation of the infrastructure and a user's registration, and verifying a cluster configuration.

7. The method for containerizing an application on a cloud platform of claim 1, wherein the converting of the application includes verifying, by the cloud platform system, functions and settings of the conversion container, registering the functions and settings in a container deployment image build and registry, and generating and testing the server.

8. The method for containerizing an application on a cloud platform of claim 1, wherein the converting of the data includes performing, by the cloud platform system, data conversion and checking data integrity when the DB solution is applied, and applying a data synchronization solution to minimize a downtime in the case of an operation application.
